(19) United States
(12) Patent Application Publication
(10) Pub. No.: US 2015/0181861 A1
(43) Pub. Date: Jul. 2, 2015

(54) Spinning Decoy System

(71) Applicant: Fowl Movement LLC, Silver Lake, MN (US)

(72) Inventors: Scott A. Butz, Fargo, ND (US); Kevin L. Nowak, Silver Lake, MN (US)

(73) Assignee: Fowl Movement LLC, Silver Lake, MN (US)

(21) Appl. No.: 14/144,055

(22) Filed: Dec. 30, 2013

(51) Int. Cl. A01M 31/06

(52) U.S. Cl. CPC A01M 31/06

(57) ABSTRACT

A spinning decoy system for effectively attracting birds by providing movement of decoys in low wind conditions. The spinning decoy system generally includes a support base positionable upon a ground surface, a frame attached to the support base, a mounting bracket rotatably attached to the frame, a plurality of support arms extending from the mounting bracket, a plurality of decoys attached to the distal portions of the support arms, and a motor mechanically connected to the mounting bracket to rotate the mounting bracket along with the support arms and decoys.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a decoy and more specifically it relates to a spinning decoy system for effectively attracting birds by providing movement of decoys in low wind conditions.

2. Description of the Related Art

Any discussion of the related art throughout the specification should in no way be considered as an admission that such related art is widely known or forms part of common general knowledge in the field.

Decoys have been in use for years. Decoys may be used for waterfowl or various other types of migratory birds, or other animals. Decoys are typically stationary and are generally positioned directly upon the ground or supported above the ground with a stake or other fixed object. The main problem with stationary decoys is that they do not provide movement and are not very realistic to animals a hunter is attempting to decoy in.

Wind powered decoys are increasingly becoming popular with hunters because of the increased realism of moving decoys that stationary decoys do not possess. One example of a wind powered decoy is illustrated in U.S. Pat. No. 7,458,181 to Scott Butz. However, wind powered decoys require wind to obtain the desired movement and unfortunately wind can be very unpredictable particularly in early morning hours.

Because of the inherent problems with the related art, there is a need for a new and improved spinning decoy system for effectively attracting birds by movement in low wind conditions.

### BRIEF SUMMARY OF THE INVENTION

The invention generally relates to a decoy system which includes a support base positionable upon a ground surface, a frame attached to the support base, a mounting bracket rotatably attached to the frame, a plurality of support arms extending from the mounting bracket, a plurality of decoys attached to the distal portions of the support arms, and a motor mechanically connected to the mounting bracket to rotate the mounting bracket along with the support arms and decoys.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention.

FIG. 3 is a top view of the present invention.

FIG. 4a is a magnified front upper perspective view of the present invention.

FIG. 4b is a magnified rear upper perspective view of the present invention with the support arms in exploded view with respect to the mounting bracket.

FIG. 5a is a magnified front upper perspective view of the present invention illustrating the drive assembly to rotate the mounting bracket.

FIG. 5b is an exploded upper perspective view of the jaw coupling.

FIG. 6 is a side view of the present invention positioned above a ground surface.

FIG. 7 is a side view of the present invention with the ground anchor attached within the ground surface to secure the invention for operation.

FIG. 8 is a magnified front upper perspective view of an alternative embodiment having a plurality of spikes to penetrate the ground surface.

FIG. 9a is a side view of the alternative embodiment positioned above a ground surface.

FIG. 9b is a side view of the alternative embodiment attached to the ground surface.

FIG. 10 is a block diagram illustrating the electrical connections of the present invention.

FIG. 11 is a magnified upper perspective view illustrating the lower bearing and the upper bearing both rotatably supporting the second shaft.

### DETAILED DESCRIPTION OF THE INVENTION

### A. Overview.

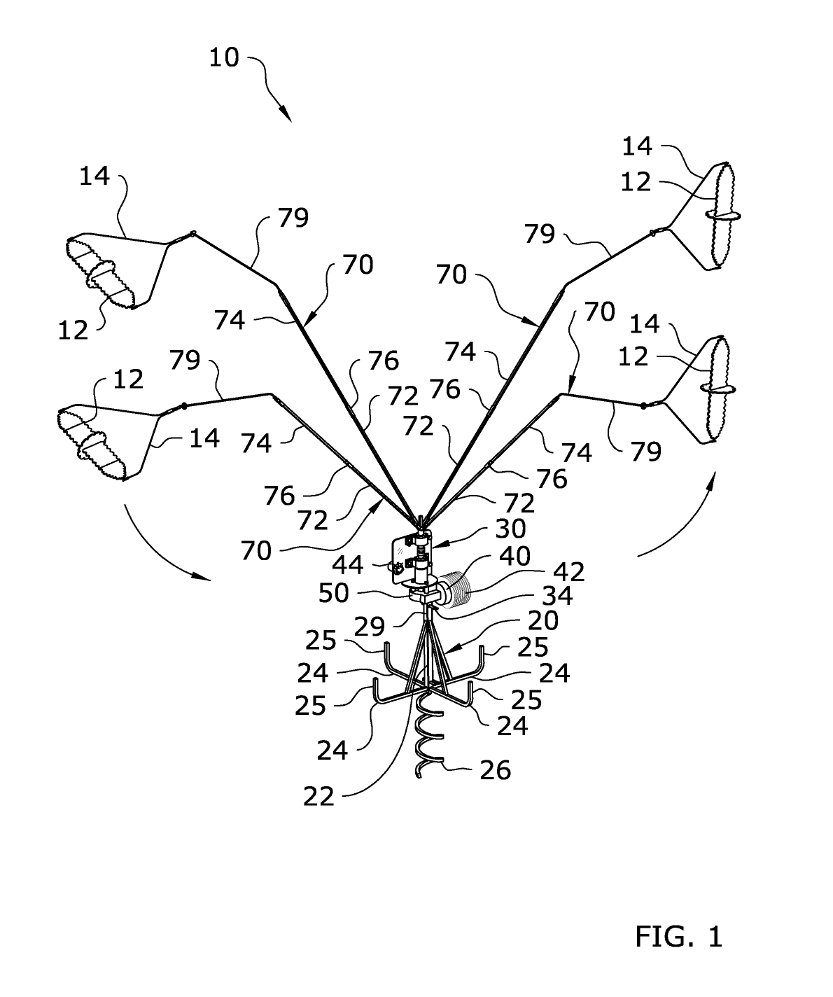

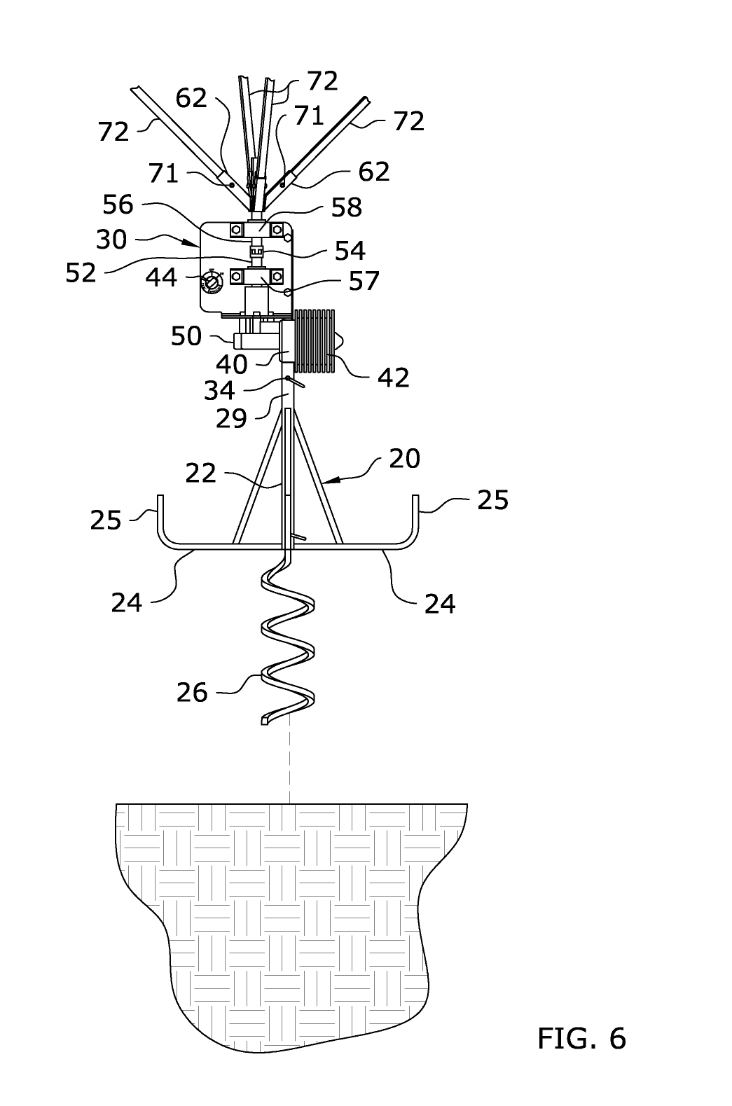

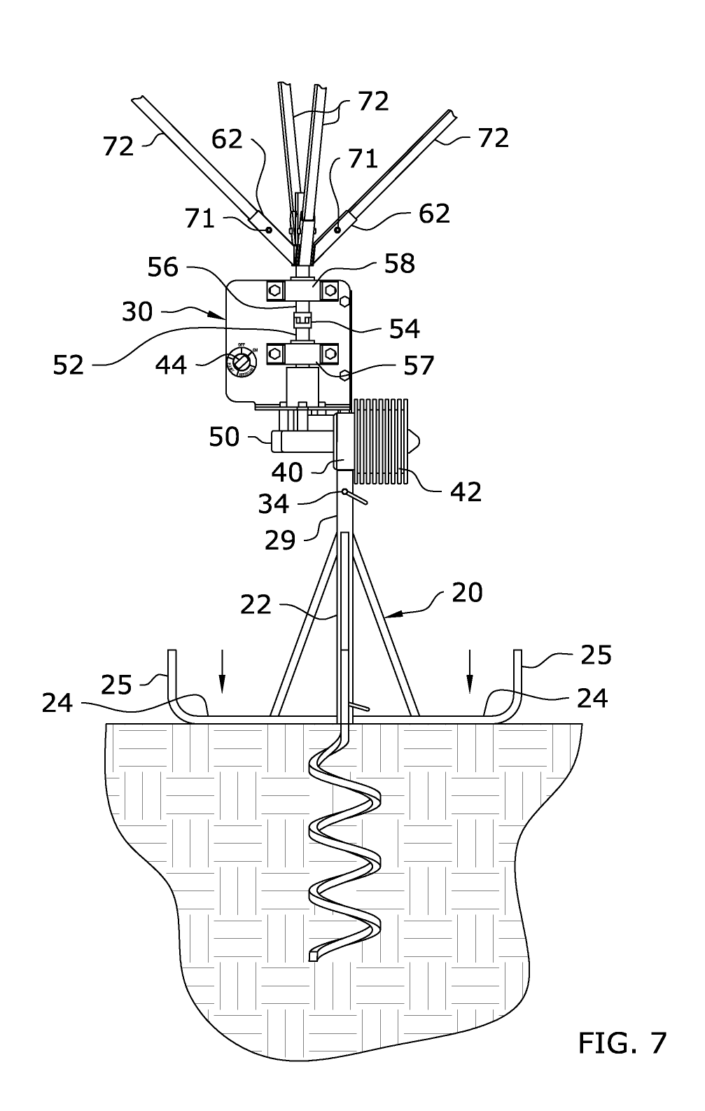

Turning now descriptively to the drawings, in which similar reference characters denote similar elements throughout the several views, FIGS. 1 through 11 illustrate a spinning decoy system 10, which comprises a support base 20 positionable upon a ground surface, a frame 30 attached to the support base 20, a mounting bracket 60 rotatably attached to the frame 30, a plurality of support arms 70 extending from the mounting bracket 60, a plurality of decoys 12 attached to the distal portions of the support arms 70, and a motor 40 mechanically connected to the mounting bracket 60 to rotate the mounting bracket 60 along with the support arms 70 and decoys 12.

### B. Frame.

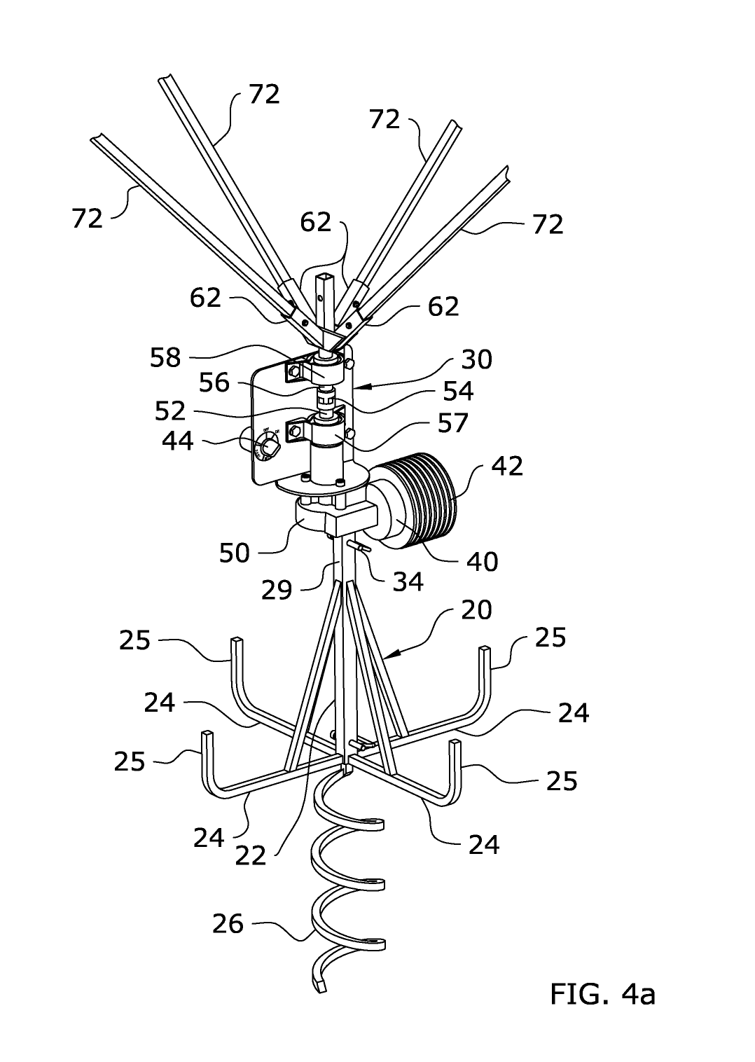

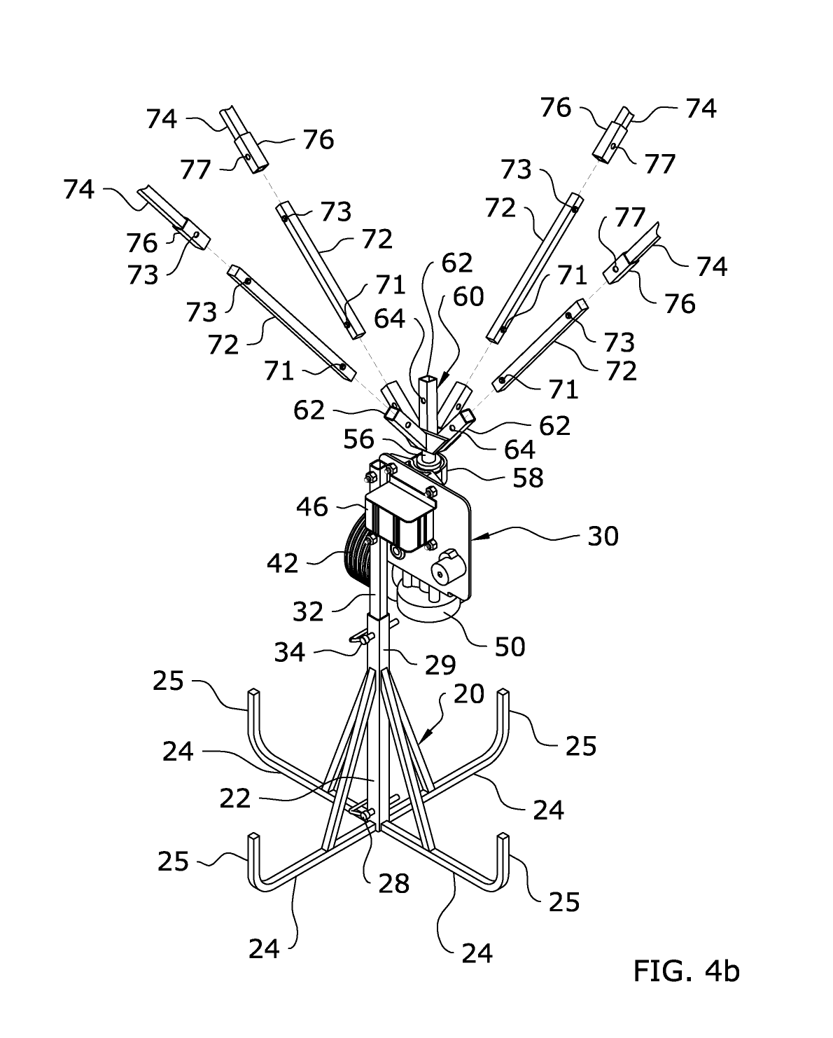

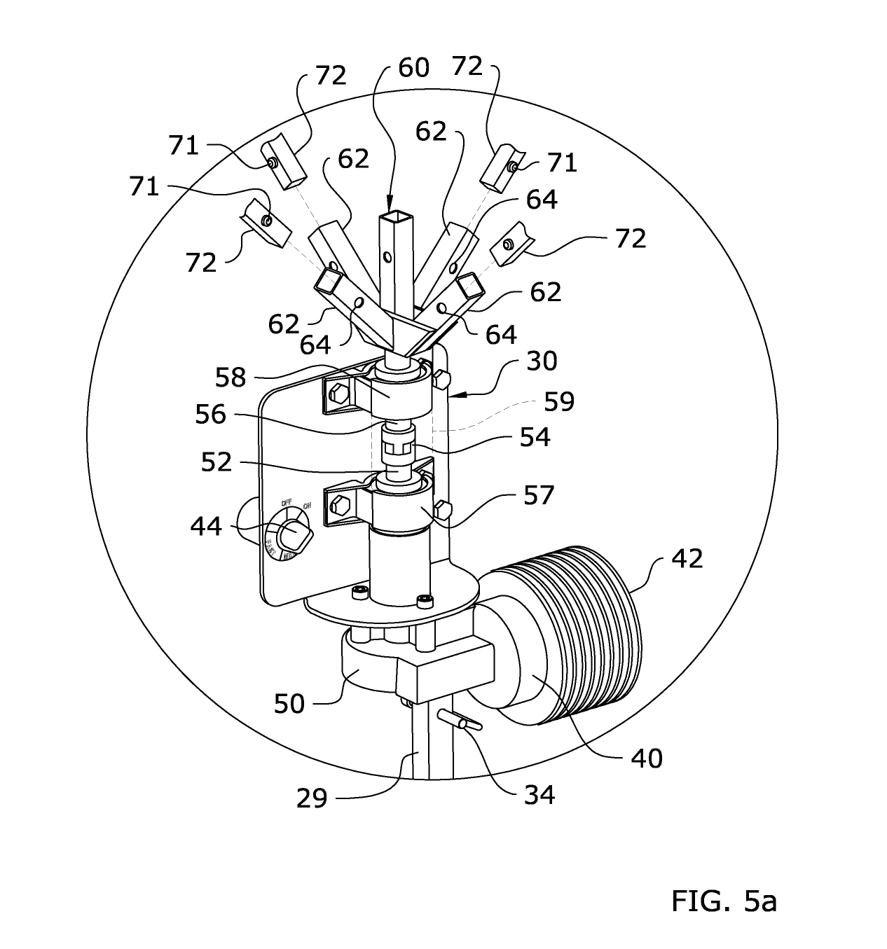

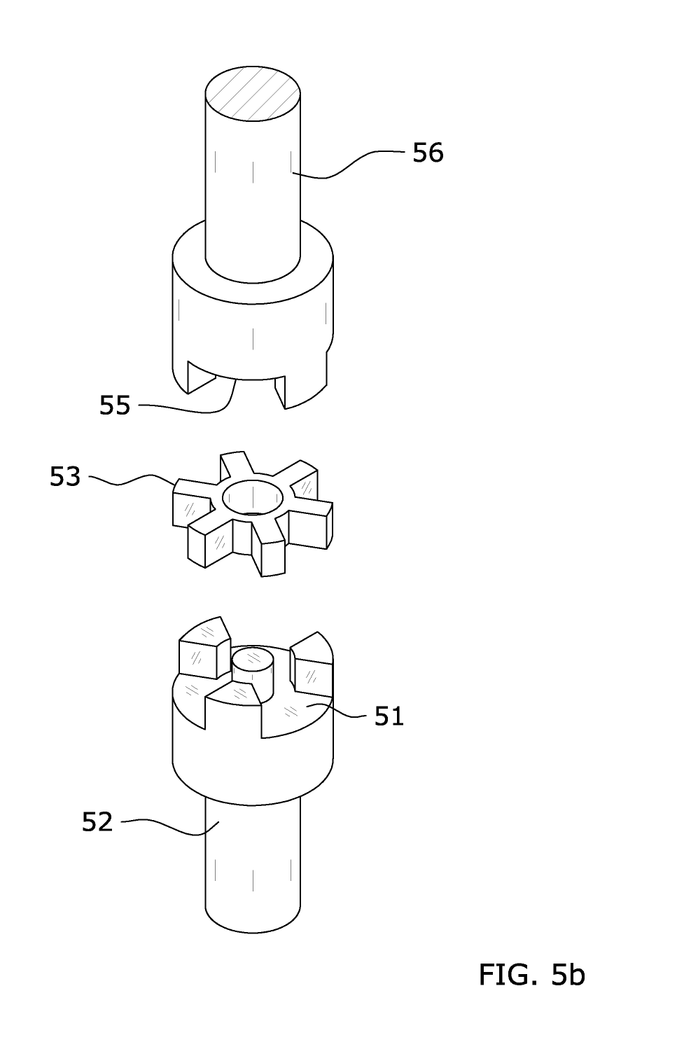

The present invention includes a frame 30 as illustrated in FIGS. 1 through 9b of the drawings. The frame 30 supports the main components of the invention such as the mounting bracket 60, the control system and the drive assembly. The frame 30 is illustrated as a flat and broad structure (see FIGS. 4a through 5b of the drawings), however, various other frame 30 configurations may be utilized.

### C. Support Base.

The present invention further preferably includes a support base 20 positionable upon a ground surface and wherein the frame 30 is attached to the support base 20. The support base 20 is adapted to either rest upon the ground surface and/or penetrate the ground surface to support the plurality of support arms 70 and decoys 12 in a stable manner.

The frame 30 may be permanently or removably attached to the support base 20. It is preferable that the frame 30 is removably attached to the support base 20 to allow for a compact storage state of the present invention when not in use. The frame 30 preferably includes a frame coupler 32 that extends downwardly from the frame 30 and is received within base coupler 29 with a securing member 34 extending through respective aligned apertures within the couplers 29, 32 as best illustrated in FIG. 4b of the drawings. The frame coupler 32 is preferably comprised of an elongated structure that has a lower end that is received within the base coupler 29, wherein the base coupler 29 is comprised of a tubular structure having an upper opening that receives the frame coupler 32. The securing member 34 may be comprised of any type of fastener or pin capable of being removably inserted into the respective apertures within the couplers 29, 32.

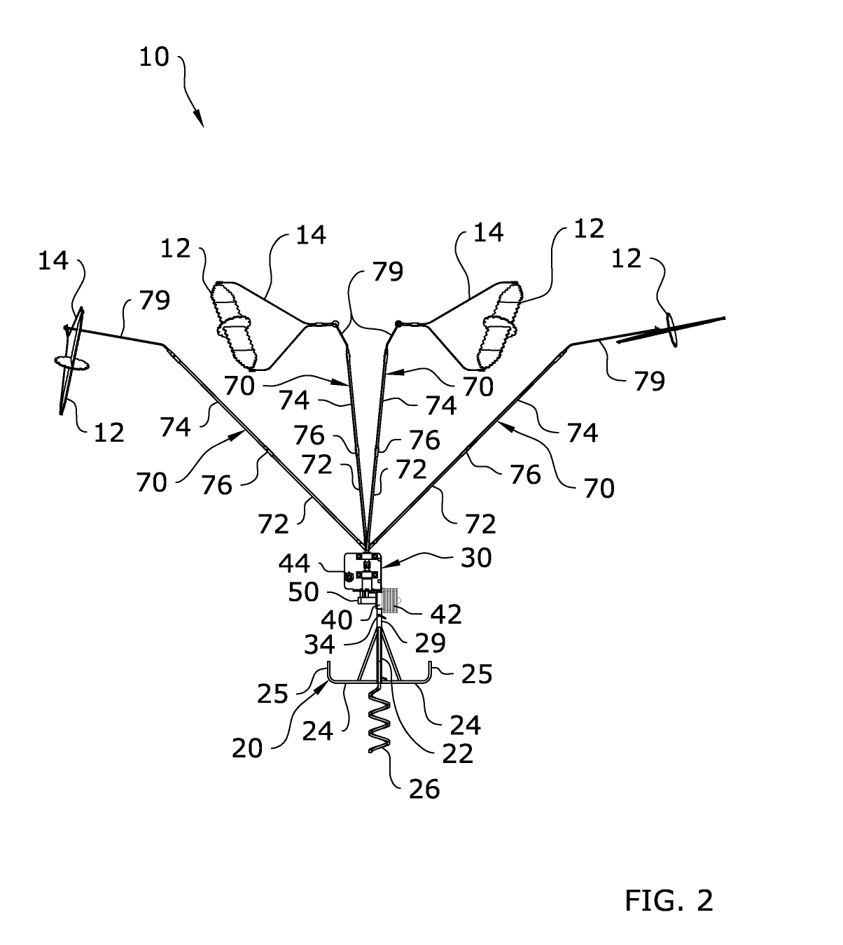

The frame 30 may be concentrically aligned with the support base 20, however, the frame 30 is preferably offset with respect to the support base 20 as best illustrated in FIGS. 2, 4a, 4b and 6 through 9b of the drawings. It is preferable that the frame 30 is offset with respect to the support base 20 to one side by at least three inches. In particular, the rotational axis of the mounting bracket 60 is preferably offset from the base coupler 29 by at least three inches to extend the life of the motor 40 by reducing the immediate load experienced by the motor 40 when initially activated because the offset allows for a partial rotation of the frame 30 with respect to the support base 20 (wherein the support base 20 is attached to the ground surface and not easily movable).

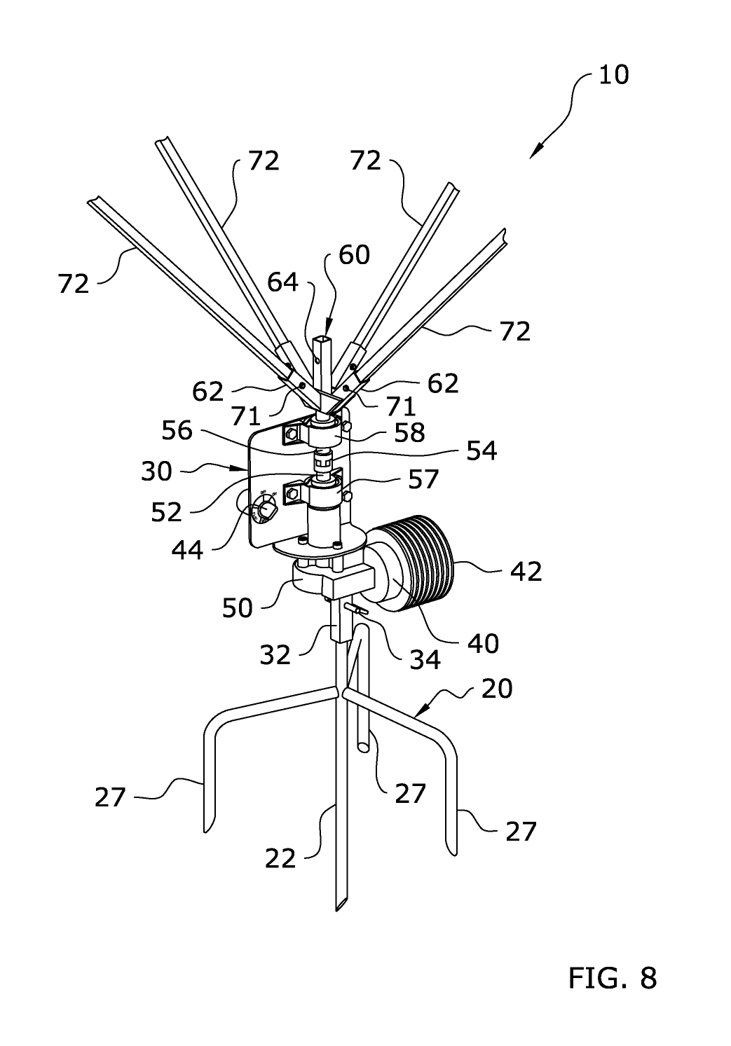

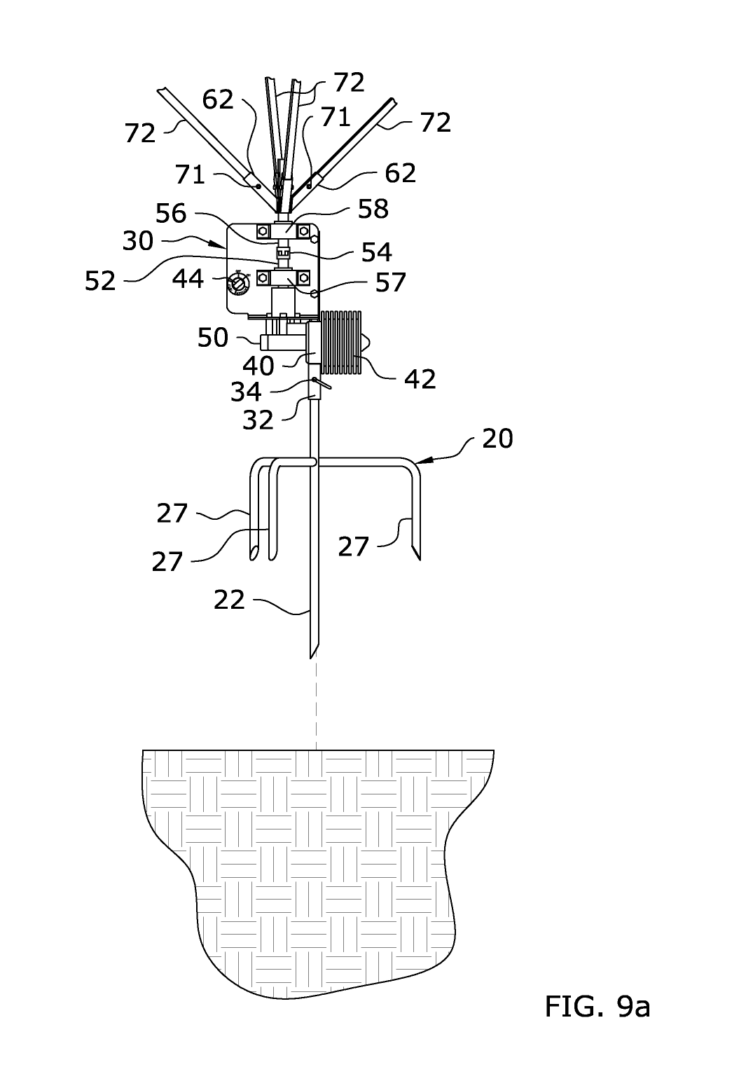

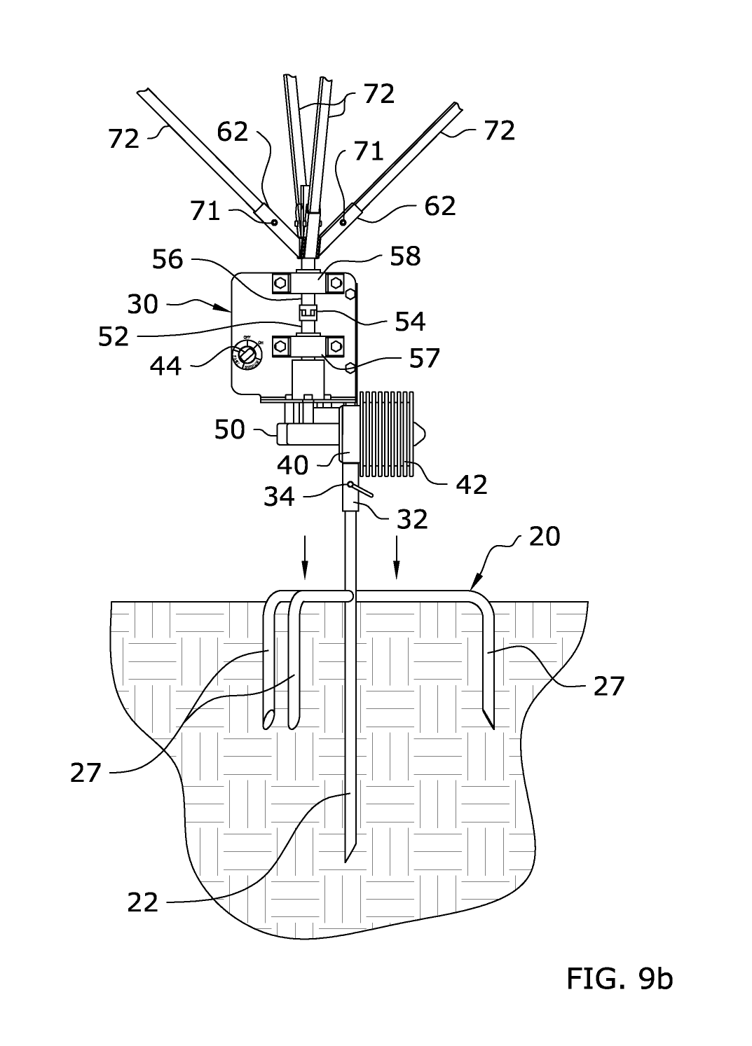

The support base 20 is comprised of a center support member 22 that extends vertically downward from the frame 30 as shown in FIGS. 4a through 4b. The support base 20 further preferably includes a plurality of extended members 24 that extend outwardly from the center support member 22. The plurality of extended members 24 preferably extend horizontally from a lower end of the center support member 22 in the embodiment illustrated in FIGS. 1 through 7 of the drawings. The plurality of extended members 24 each preferably include an upwardly extending portion 25 in the embodiment shown in FIGS. 1 through 7 of the drawings. In the alternative embodiment illustrated in FIGS. 8 through 9b of the drawings, the plurality of extended members 24 each include a downwardly extending spike 27 to penetrate the ground surface and the center support member 22 includes a pointed end to penetrate the ground surface.

In the embodiment illustrated in FIGS. 1 through 7 of the drawings, a coil anchor 26 is attached to the support base 20 either permanently or removably. It is preferable that the coil anchor 26 be removably connected to allow for compact storage and transportation of the present invention. The coil anchor 26 is rotated into and out of the ground by the user manipulating the support base 20 thereby causing corresponding rotation of the coil anchor 26. The coil anchor 26 preferably has an upper portion that is removably received within a lower opening within the center support member 22 and retained by an anchor securing member 34 28 selectively extending through corresponding apertures of the upper portion of the coil anchor 26 and the lower portion of the center support member 22.

### D. Mounting Bracket.

The mounting bracket 60 is rotatably attached to the frame 30 and preferably extends upwardly from the frame 30. The mounting bracket 60 includes a plurality of mounting receivers 62 that are comprised of a tubular structure that removably receive the support arms 70 as illustrated in FIGS. 4a through 9b of the drawings. The mounting receivers 62 each preferably include a receiver aperture 64 that is aligned with a corresponding first biased member 71 extending from the inner end of the support arms 70 thereby allowing for quick release and removal of the support arms 70 from the mounting bracket 60.

The mounting receivers 62 of the mounting bracket 60 preferably extend upwardly at an angle and are distally spaced apart. It is preferable that the angle of the mounting receivers 62 is approximately 45 degrees as best illustrated in FIG. 2 of the drawings. There are a plurality of mounting receivers 62 extending from the mounting bracket 60 and a center mounting receiver extending vertically upward to support the support arms 70 at corresponding angles. The mounting receivers 62 are preferably comprised of sets of two with one of the set on one side of the mounting bracket 60 and the other on the opposite side of the mounting bracket 60 to provide a desired weight balance to the mounting bracket 60 during operation.

### E. Support Arms.

The present invention further includes a plurality of support arms 70 that extend from the mounting bracket 60. While the support arms 70 may be permanently attached to the mounting bracket 60, it is preferable that the support arms 70 are removably attached to the mounting bracket 60 to provide for compact storage and transportation of the present invention. The support arms 70 may have various lengths (e.g. 2-8 feet) and cross sectional shapes (e.g. square, rectangular, circular). The support arms 70 are preferably comprised of a tubular material but may be comprised of non-tubular materials. The inner end of the support arms 70 includes a first biased member 71 that is spring biased to extend outwardly and may be depressed to be inserted (or removed) from the corresponding mounting receivers 62 wherein the first biased member 71 is catchably received within the receiver aperture 64 of the corresponding mounting receivers 62.

The support arms 70 are preferably comprised of a multi-piece construction allowing for the disassembly of each of the support arms 70 for compact storage after removal from the mounting bracket 60. In particular, the support arms 70 are each preferably comprised of a first segment 72 that removably connects to the mounting bracket 60 and a second segment 74 that removably connects to the distal end of the first segment 72. The first segment 72 and the second segment 74 are preferably concentrically aligned with respect to one another when attached as illustrated in FIGS. 1 and 2 of the drawings.

The inner end of the first segment 72 includes the first biased member 71 that is catchably received by the receiver aperture 64. The distal end of the first segment 72 includes a second biased member 73 having a structure and function equal to the first biased member 71. The second biased member 73 is catchably received within a first aperture 77 within the second segment 74 as illustrated in FIGS. 4a through 5a. The second segment 74 further preferably includes a receiver sleeve 76 that has an interior opening that is larger than the outer portion of the distal end of the first segment 72 as shown in FIG. 4b of the drawings. The first aperture 77 is within the receiver sleeve 76 of the second segment 74.

Each of the support arms 70 may also include a third segment 79 extending from the distal end of the second segment 74 at a lower angle as shown in FIG. 2 of the drawings. The lower angle is approximately 5-10 degrees as best illustrated in FIG. 2 of the drawings. The third segment 79 may be permanently or removably attached to the second segment 74. The third segment 79 is preferably comprised of a material and structure that has a higher flexibility than the first segment 72 and the second segment 74 to provide for some additional movement of the decoys 12 during operation.

### F. Decoys.

The plurality of decoys 12 are attached to the distal portions of the support arms 70 as illustrated in FIGS. 1 through 3 of the drawings. The decoys 12 may be supported by string 14, wire or other elongated flexible structure. The decoys 12 may be comprised of various types of decoy structures such as a non-moving decoy or moving decoy. FIGS. 1 through 3 illustrate the usage of an exemplary moving decoys 12 comprised of a rotating decoy. U.S. Pat. No. 7,458,181 to Scott Butz illustrates an exemplary type of moving decoy suitable for use with the present invention and is hereby incorporated by reference.

### G. Drive Assembly.

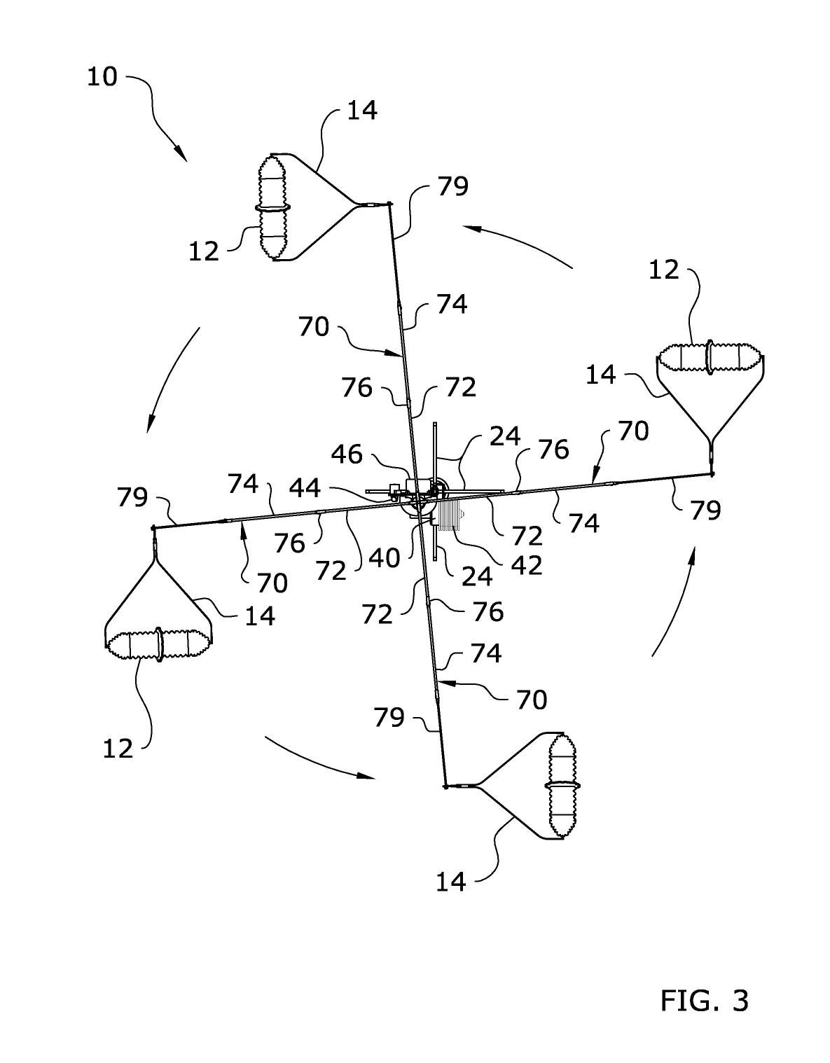

The drive assembly is attached to the frame 30 and mechanically connected to the mounting bracket 60 to cause rotation of the mounting bracket 60. The rotational axis of the mounting bracket 60 is vertical with respect to the ground surface as best illustrated in FIGS. 2 and 3 of the drawings.

A motor 40 (e.g. electric motor 40) is preferably mechanically connected to the mounting bracket 60 by a drive assembly to rotate the mounting bracket 60 along with the support arms 70 and the plurality of decoys 12. The motor 40 includes a heat sink 42 attached to the external portion of the motor 40 to assist in dissipating heat during extended periods of usage. The heat sink 42 is comprised of a metal finned structure that conducts the heat from the motor 40 and transfers the heat to the surrounding air.

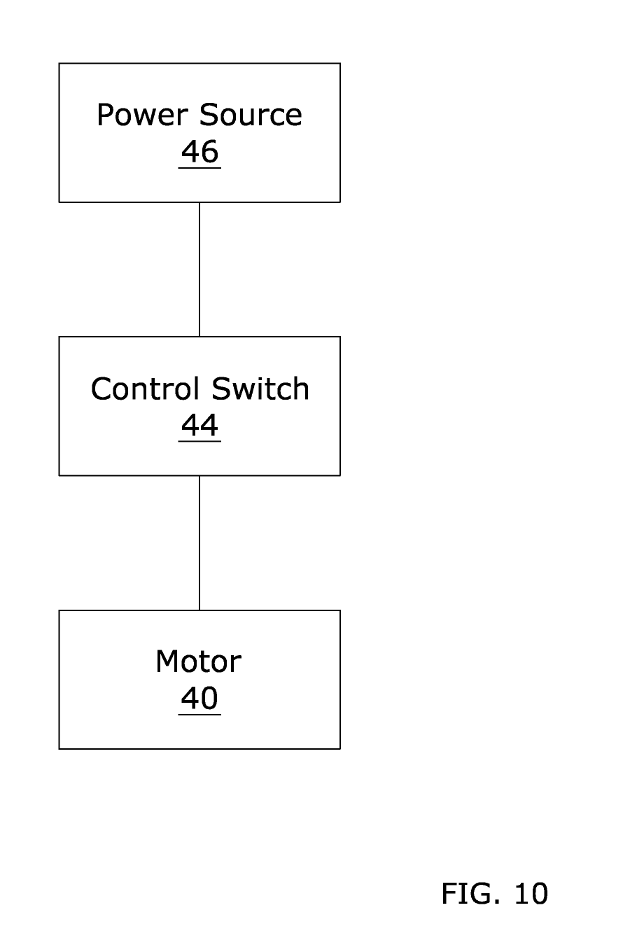

A control switch 44 is connected between the power source 46 (e.g. battery) and the motor 40 to control a rotational speed of the motor 40 as illustrated in FIG. 10 of the drawings. The control switch 44 is attached to the frame 30 and includes surrounding indicia regarding the rotational velocity of the mounting bracket 60 and corresponding support arms 70 (and decoys 12). The indicia preferably includes a power off indicator, a first bird type zone and a second bird type zone, wherein the first bird type zone indicates the rotational speed for snow geese and the second bird type zone is for ducks. The rotational speed for the mounting bracket 60 for the first bird type zone is slower than the second bird type zone.

The drive assembly further includes a gearbox 50 connected between the mounting bracket 60 and the motor 40 to reduce the rotational velocity delivered from the motor 40 to the mounting bracket 60 so the mounting bracket 60 rotates slower than the rotation of the drive shaft of the motor 40. As illustrated in FIG. 5a of the drawings, a first shaft 52 is connected to the gearbox 50, a second shaft 56 is connected to the mounting bracket 60 and a coupling 54 is connected between the first shaft 52 and the second shaft 56 to connect the shafts together in a semi-movable manner.

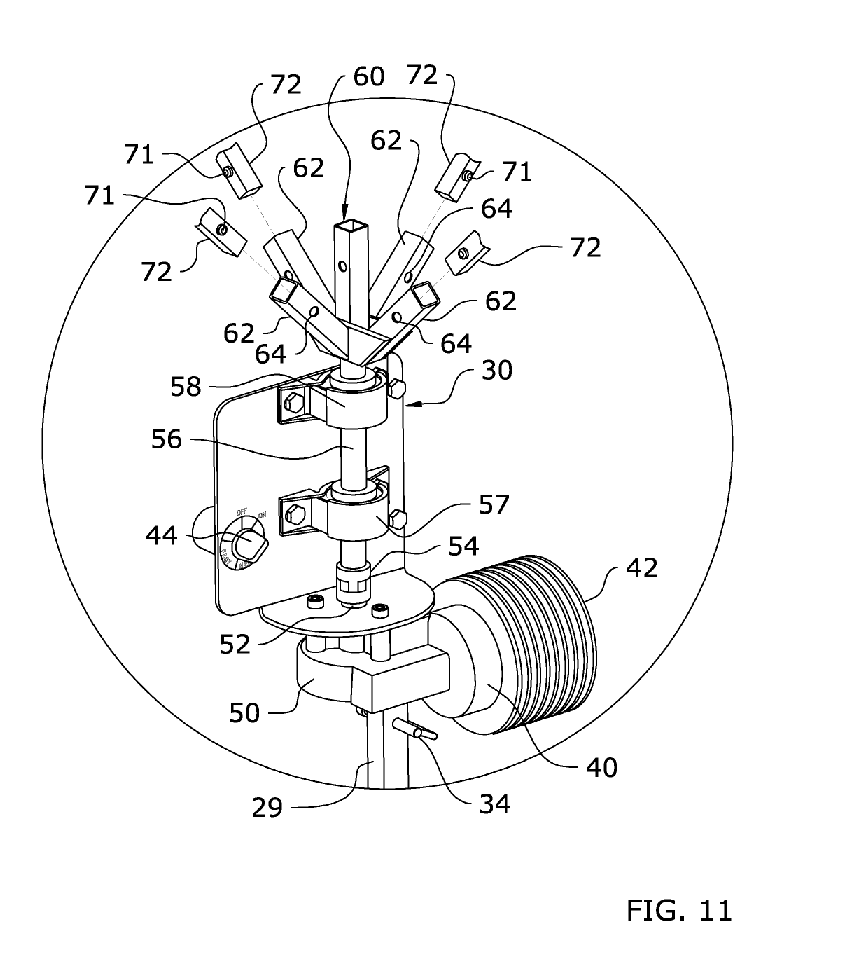

A lower bearing 57 is connected to the frame 30 and rotatably receives the first shaft 52 as shown in FIG. 5a. An upper bearing 58 is connected to the frame 30 and rotatably receives the second shaft 56 as further shown in FIG. 5a. The first shaft 52 is concentrically aligned with the second shaft 56 when the shafts are connected together by the coupling 54. In an alternative embodiment shown in FIG. 11, both the lower bearing 57 and the upper bearing 58 rotatably support the second shaft 56 with the first shaft 52 directly coming from the gearbox 50.

The coupling is preferably comprised of a jaw coupling 54 to reduce the amount of impact resistance the motor 40 experiences when first started by absorbing some of the rotational movement of the motor 40. As illustrated in FIG. 5b of the drawings, the jaw coupling 54 is comprised of a first coupling body 51 with a first set of teeth, a second coupling body 55 with a second set of teeth and a spacer 53 having a plurality of spacer 53 teeth, wherein the spacer 53 teeth are positioned between the first set of teeth and the second set of teeth. The spacer 53 is comprised of a plastic material or rubber material to provide for absorption of some of the initial rotational force applied to the motor 40 during initial startup and when the motor 40 is turned off. U.S. Pat. No. 3,895,502 to Schwarz illustrates an exemplary jaw coupling 54 and is incorporated by reference herein.

A protective housing 59 preferably surrounds the jaw coupling 54. The protective housing 59 may be comprised of a tubular structure to prevent debris and humans from contacting the jaw coupling 54 during use. The protective housing 59 preferably extends from the lower bearing 57 to the upper bearing 58 as illustrated in dashed lines in FIG. 5a.

### H. Operation of Preferred Embodiment.

In use, the user secures the support base 20 to the ground surface and then determines the type of birds to be decoyed in. The user then adjusts the control switch 44 to the zone that corresponds to the type of bird to be decoyed in to achieve the desired rotational velocity of the mounting bracket 60 and corresponding decoys 12. The user may adjust the rotational velocity as they determine is required. When the motor 40 is first started, the rotational force from the drive shaft of the motor 40 causes rotation of the first shaft 52 which then causes rotation of the jaw coupling 54 and then the second shaft 56 which is connected to the mounting bracket 60. Because of the length of the support arms 70 and the decoys 12 attached, there is a significant amount of resistance to rotation by the mounting bracket 60 when the motor 40 is first started. The combination of the jaw coupling 54 which absorbs a portion of the rotational along with the offset of the rotational axis of the mounting bracket 60 which absorbs some of the initial rotational force prevents damages to the motor 40. In addition, when the user turns off the motor 40 with the control switch 44, the momentum of the mounting bracket 60 and support arms 70 does not significant jar or impact the motor 40 which is decelerating the drive shaft rotation. When the user is finished, they separate the components of the present invention for storage and transportation.

During rotation of the mounting bracket 60, the decoys 12 are rotated in a corresponding direction (clockwise or counterclockwise viewed from the top). The decoys 12 illustrated in FIGS. 1 and 2 of the drawings spin in a normal manner when traveling perpendicular to and against the wind. However, when one of the decoys 12 momentarily travels within the 90 degree direction of rotation following the direction of the wind the decoy 12 flutters and falls from the flying height position relative to the ground similar to how waterfowl (e.g. geese and ducks) land in a field while the other decoys 12 remain at their respective height. The momentary fall makes the decoy 12 appears as if it were a bird landing to feed. The falling motion of the decoy 12 is followed by a quick flash and the decoy 12 then rises up quickly to its normal height to finish another complete revolution. The periodic falling and rising of the decoys 12 adds the appearance of chaos to the decoy spread and makes the movement of the decoys 12 look more spontaneous and lifelike to the birds being decoyed.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A spinning decoy system, comprising:
a frame;
a mounting bracket rotatably attached to said frame;
a plurality of support arms extending from said mounting bracket;
a plurality of decoys attached to said distal portions of said support arms; and
a motor mechanically connected to said mounting bracket by a drive assembly to rotate said mounting bracket along with said support arms and said plurality of decoys.

2. The spinning decoy system of claim 1, including a support base positionable upon a ground surface, wherein said frame is attached to said support base.

3. The spinning decoy system of claim 2, wherein said frame is offset with respect to said support base.

4. The spinning decoy system of claim 2, wherein said frame is removably attached to said support base.

5. The spinning decoy system of claim 2, wherein said support base is comprised of a center support member that extends vertically downward from said frame.

6. The spinning decoy system of claim 5, wherein said support base includes a plurality of extended members that extend outwardly from said center support member.

7. The spinning decoy system of claim 6, wherein said plurality of extended members extend horizontally from a lower end of said center support member.

8. The spinning decoy system of claim 7, wherein said plurality of extended members each include an upwardly extending portion.

9. The spinning decoy system of claim 8, including a coil anchor attached to said support base.

10. The spinning decoy system of claim 7, wherein said plurality of extended members each include a downwardly extending spike.

11. The spinning decoy system of claim 1, wherein said motor includes a heat sink.

12. The spinning decoy system of claim 1, including a control switch connected to said motor to control a rotational speed of said motor.

13. The spinning decoy system of claim 1, wherein said drive assembly includes a gearbox connected between said mounting bracket and said motor, wherein said gearbox reduces a rotational velocity from said motor to said mounting bracket.

14. The spinning decoy system of claim 13, including a first shaft connected to said gearbox, a second shaft connected to said mounting bracket and a coupling connected between said first shaft and said second shaft.

15. The spinning decoy system of claim 14, wherein said coupling is comprised of a jaw coupling.

16. The spinning decoy system of claim 15, wherein said jaw coupling is comprised of a first coupling body with a first set of teeth, a second coupling body with a second set of teeth and a spacer having a plurality of spacer teeth, wherein said spacer teeth are positioned between said first set of teeth and said second set of teeth.

17. The spinning decoy system of claim 16, wherein said spacer is comprised of a plastic material.

18. The spinning decoy system of claim 15, including a protective housing surrounding said jaw coupling.

19. The spinning decoy system of claim 14, including a lower bearing connected to said frame and rotatably receiving said first shaft, and an upper bearing connected to said frame and rotatably receiving said second shaft.

20. The spinning decoy system of claim 14, wherein said first shaft is concentrically aligned with said second shaft.
